(19) United States
(12) Patent Application Publication
(10) Pub. No.: US 2026/0120112 A1
(43) Pub. Date: Apr. 30, 2026

(54) SYSTEM AND METHOD FOR OPTIMIZING CUSTOMER EXPERIENCE TRANSFORMATION BY ANALYSING VOICE OF CUSTOMER

(71) Applicant: Smarter Biz Technologies Pvt. Ltd., Bengaluru (IN)

(72) Inventors: Vijaya Krishna BELLALCHERU SADASHIVA, Bengaluru (IN); Prateek MEHTA, Bengaluru (IN)

(73) Assignee: Smarter Biz Technologies Pvt. Ltd., Bengaluru (IN)

(21) Appl. No.: 19/373,822

(22) Filed: Oct. 30, 2025

(30) Foreign Application Priority Data
Oct. 30, 2024 (IN) 202441083521

(51) Int. Cl. G06Q 30/01; G06Q 10/0639; G10L 15/183; G10L 25/30

(52) U.S. Cl. CPC G06Q 30/01; G06Q 10/06393; G10L 15/183; G10L 25/30

(57) ABSTRACT

Disclosed herein is a system and method for optimizing customer experience transformation by analysing voice-of-customer using AI and ML techniques. The flow diagram of the method shown in FIG. 2B comprises the steps of: setting business objectives for a business organization, mapping the business objectives to key performance indices of the business organization, providing interfaces for collecting voice of customer data from various channels, interfacing key knowledge management system and CRM to map customer information from various channels to triage with the collected voice of customer data, mapping each business objective and related key performance indices to attributes to be identified in voice of customer data, analysing voice of customer data to find results and weightages for each attribute and the key performance indices, generating process transformation report to recommend changes for enhancing the key performance indices and measuring and monitoring continuously key performance indices till optimal thresholds are reached.

### RELATED APPLICATION(S)

This application claims the benefit of priority of Indian Patent Application number 202441083521 filed on Oct. 30, 2024, the contents of which are incorporated by reference as if fully set forth herein in their entirety.

### FIELD AND BACKGROUND OF THE INVENTION

The present invention generally relates to methods for optimizing customer experience. More particularly, the present invention relates to a system and business method for optimizing customer experience transformation using artificial intelligence (AI) and machine learning (ML) techniques.

In the modern world of business, customer experience (hereinafter referred to as CX) plays a major role in determining success. CX is the engagement of a business with its customers i.e., how well a business satisfies the expectations of a customer or consumer at every point in their journey. The expectations of a customer are the actions which they anticipate while associating with a business. This includes responding to queries from the customer in a timely manner, considering customer feedback, etc., and meeting expectations leads to the satisfaction of a customer and satisfaction determines the success of a business organization.

There are many ways to achieve customer satisfaction. However, most of the organizations prefer to set a business process. Generally, business organizations or enterprises have their very own business process that is aligned to delight the customer or meet their core business objectives in the most efficient and compliant manner. Also, in modern times, to provide enhanced CX, business organizations employ different strategies which are powered by Artificial Intelligence (hereinafter referred to as AI) and Machine Learning (hereinafter referred to as ML) techniques.

More specifically, in recent times, customer satisfaction is achieved by mainly focusing on “voice of customer” (hereinafter referred to as VoC). VoC is the feedback and expectation of a customer. In the modern CX teams within an enterprise, they are various touchpoints like voice calls, chat, emails, feedback forms, etc with the customer for tracking or recording the conversations for analysis and thereby improving their business. The analysis of about 2-3% of these conversations using human auditors who listen to “voice of customer” obtained from various touch points and fill out a pre-set form. Based on the manual scoring done for the forms, CX teams draw strategies and arrive at process transformation journeys and redesign existing processes to customer centric processes. They measure the attributes on a continuous basis to make corrections and achieve incremental benefits over several years. But, the percentage of analysis is too small for effective impact as the business cost structure does not allow to go beyond 2-3%. Also, the changes planned from the analysis is laborious and expensive as it requires to deploy customer forms, agent scripts, data gathering tools across multiple IT systems involved in the organization.

There are many prior art relating to methods for improving customer experience. For example, Chinese Patent Number 115053244 entitled “System and method for analysing customer contact” to Swaminathan Sivasubramanian et. al., relates to analysing customer contact data. The contact data of customers are encoded as text, audio, and various other modalities. A computing resource service provider implement services to: obtain audio data from a client, transcribe the audio data for generating text, performing one or more natural language processing techniques to generate metadata associated with the text for processing the metadata to generate an output, determining whether the output matches one or more categories and providing the output to the client.

U.S. Pat. No. 10,528,671 entitled “System and method for actionizing comments using voice data” to Kyle Robertson and Taylor Turpen relates to processing and actionizing structured and unstructured experience data. The system includes a natural language processing engine which transform a data set into a plurality of concepts within a plurality of distinct contexts, and a data mining engine which process the relationships of the concepts and identify associations and correlations in the data set. The method includes the steps of receiving a data set, scanning the data set with an NLP engine to identify a plurality of concepts within a plurality of distinct contexts, and identifying patterns in the relationships between the plurality of concepts. The data set include voice data from a voice-based assistant or a voice based survey.

Indian Patent Application number 202341076490 entitled “System/method to recognize emotion from text and feedback analysis” to Gonuru Sowmya et. al., relates to detect emotions in text and provide insightful feedback for business organizations. The system for comprises input module, text embedding module, deep learning model and output module. The operation of the system comprises the steps of receiving textual content, processing the content by tokenization, converting the content into numerical vectors using text embedding techniques, classifying numerical vectors into one or more emotion categories, generating contextually relevant response based on detected emotion categories, generating response to the user and helping the organization to improve the customer satisfaction.

Though there are many prior art relating to customer experience solutions, none of them disclose a single, comprehensive AI-based tool to analyse Voice of Customer (VoC) data across various touchpoints for continuous business process improvement. Multiple tools that gather information across channels also depend on human effort to analyse the data manually and recommend strategies to improve customer centricity.

Further, most of the current VoC is analysed on areas like customer sentiment, feedback etc. But they are not aware to business process specific insights and do not have a closed loop to make recommendations to transform the process, measure the impact and fine-tune on a continuous basis till the desired process outcomes are met. The following are the most commonly faced challenges in the existing solutions:
Manual processes restrict analysis to a small percentage of data i.e., only 2-3% of customer conversations due to high costs and laborious processes
Automation tools lack depth in business process-specific insights i.e., limited automation tools which focus solely on customer sentiment and high-level analysis
Lack of closed-loop feedback mechanisms to drive process transformation and continuous improvement
Existing systems require human intervention for deploying CX process changes
Standalone voice bots fail to learn and adapt for optimal customer engagement

Hence, there is a need for a method that optimizes customer experience automatically with accurate customer input data to overcome the aforementioned challenges. Further, to also sustain in the modern world of business, there is a need for a method that makes use of AI technology to enhance customer experience.

### OBJECTIVES OF THE INVENTION

The primary objective of the present invention is to provide a system for optimizing customer experience transformation using artificial intelligence (AI) and machine learning (ML) techniques.

Another objective of the present invention is to provide a method for optimizing customer experience transformation using artificial intelligence (AI) and machine learning (ML) techniques.

Yet another objective of the present invention is to provide a method for optimizing customer experience that automates VoC gathering, analyses large datasets, and recommends optimal CX process changes.

Yet another objective of the present invention is to provide a method for revolutionizing customer experience management making it more effective, and customer-centric.

Still another objective of the present invention is to provide a method that define the process objectives without any human intervention and identifies the key performance factors which are essential to meet the process objectives.

### SUMMARY OF THE INVENTION

The present invention discloses a system and method for optimizing customer experience transformation using AI and ML techniques.

According to the present invention, the system comprises:
a distributed storage architecture for storing structured and unstructured VoC data in a scalable data lake, for real-time data retrieval and analysis from various customer feedback channels and business insights;
a multi-channel ingestion framework utilizing APIs, edge computing, and secure data protocols for collecting and pre-processing voice-of-customer data from social media, call centers, emails, and enterprise systems, for seamless integration of data from diverse sources;
a language model and an end-to-end speech-trained model employing advanced techniques such as transformers and convolutional neural networks to process, analyze, and interpret VoC data, offering high accuracy in sentiment detection, intent recognition, and predictive analytics across multiple languages and accents;
a real-time anomaly detection and predictive analytics engine leveraging ensemble learning and unsupervised ML techniques to identify outliers, detect emerging trends, and predict future customer behaviors, ensuring continuous improvement in customer experience strategies; and
a secure and compliant data privacy mechanism, incorporating encryption standards and differential privacy algorithms to protect customer data ensuring compliance with global data protection regulations during AI/ML model training and operation.
   In accordance to the present invention, the method comprises the steps of:
a. defining business objectives for a business organization;
b. mapping the defined business objectives to key performance indices (KPIs) relevant to the organization;
c. providing interfaces for collecting voice of customer data from various communication channels including social media, emails, call centers, and web forms;
d. integrating knowledge management systems and customer relationship management (CRM) platforms to associate customer data with the collected VoC data for further analysis;
e. mapping each business objective and corresponding KPIs to relevant attributes within the VoC data;
f. analysing the VoC data using an NLP-based language model and speech-trained model to determine attribute values and weighted contributions to each KPI, with high accuracy in sentiment detection and intent recognition across multiple languages and dialects;
g. utilizing a real-time anomaly detection and predictive analytics engine to identify outliers, detect emerging trends, and predict customer behaviors, and generating a process transformation report with recommendations for optimizing business processes and enhancing the KPIs; and
h. continuously monitoring and measuring the KPIs to ensure performance targets and optimal thresholds are achieved, utilizing predictive analytics for proactive customer experience improvements.

The method also aligns attributes to measure in line with this key performance indices/factors and analyse 100% of VoC across various channels to measure the status of each of these attributes, assess weightages to reach these attributes for optimal outcome, recommend continuous changes, measure the on-going changes and continue fine-tuning of the process till the process objectives meet the optimal values for the enterprise.

Further, the method uses AI to gather voice of customers across all the customer touch points automatically into a single system. The CX team goals are then taken and a customer centric process transformation blueprint is recommended with AI generated personalized training modules to agents, and voice-bots that autonomously function to the optimal CX process. This method also continuously measures and fine-tune the process till the desired process goals achieve optimum values.

These objectives and advantages of the present invention will become more evident from the following detailed description when taken in conjunction with the accompanying drawings.

### BRIEF DESCRIPTION OF THE SEVERAL VIEWS OF THE DRAWING(S)

The objective of the present invention will now be described in more detail with reference to the accompanying drawing, wherein:

FIG. 1 shows the overall design of the system disclosed in the present invention;

FIGS. 2A and 2B show the flow diagrams of the method disclosed in the present invention;

FIG. 3 shows the flow diagram of the impact of voice of customer based on the method disclosed in the present invention;

FIG. 4 shows the process/business goals disclosed in the present invention;

FIGS. 5A. 5B, 5C and 5D show the sample analysis of various parameters considered in the method disclosed in the present invention;

FIG. 6 shows the process/business goals of an example application of the present invention; and

FIGS. 7A, 7B and 7C shows the working of example application of the present invention.

### DESCRIPTION OF SPECIFIC EMBODIMENTS OF THE INVENTION

The present invention discloses a system and method for optimizing customer experience transformation using AI and ML techniques.

According to the present invention, the system comprises:
a distributed storage architecture for storing structured and unstructured VoC data in a scalable data lake, for real-time data retrieval and analysis from various customer feedback channels and business insights;
a multi-channel ingestion framework utilizing APIs, edge computing, and secure data protocols for collecting and pre-processing voice-of-customer data from social media, call centers, emails, and enterprise systems, for seamless integration of data from diverse sources;
a language model and an end-to-end speech-trained model employing advanced techniques such as transformers and convolutional neural networks to process, analyze, and interpret VoC data, offering high accuracy in sentiment detection, intent recognition, and predictive analytics across multiple languages and accents;
a real-time anomaly detection and predictive analytics engine leveraging ensemble learning and unsupervised ML techniques to identify outliers, detect emerging trends, and predict future customer behaviors, ensuring continuous improvement in customer experience strategies; and
a secure and compliant data privacy mechanism, incorporating encryption standards and differential privacy algorithms to protect customer data ensuring compliance with global data protection regulations during AI/ML model training and operation.
   In accordance to the present invention, the method comprises the steps of:
a. defining business objectives for a business organization;
b. mapping the defined business objectives to key performance indices (KPIs) relevant to the organization;
c. providing interfaces for collecting voice of customer data from various communication channels including social media, emails, call centers, and web forms;
d. integrating knowledge management systems and customer relationship management (CRM) platforms to associate customer data with the collected VoC data for further analysis;
e. mapping each business objective and corresponding KPIs to relevant attributes within the VoC data;
f. analysing the VoC data using an NLP-based language model and speech-trained model to determine attribute values and weighted contributions to each KPI, with high accuracy in sentiment detection and intent recognition across multiple languages and dialects;
g. utilizing a real-time anomaly detection and predictive analytics engine to identify outliers, detect emerging trends, and predict customer behaviors, and generating a process transformation report with recommendations for optimizing business processes and enhancing the KPIs; and
h. continuously monitoring and measuring the KPIs to ensure performance targets and optimal thresholds are achieved, utilizing predictive analytics for proactive customer experience improvements.

The method disclosed in the present invention is an AI recommendation engine that analyses a large quantum of historic voice and non-voice data of a specific process/sub-process of the enterprise basis which it auto-builds/creates/recommends an optimal framework of engagement for that process taking into account the combination of voice automation and agent engagement. The AI set up auto learns itself through feedback loop mechanism to derive the most optimum end results in terms of objectives defined like customer experience, risk assessment, debt collections, cost reduction.

The present invention addresses the challenges faced by enterprises which are listed below:
Aligning business processes with customer-centric approaches to improve customer satisfaction, retention, loyalty, and Net Promoter Score (NPS).
Efficiently gathering and analysing Voice of Customer (VoC) data from various touchpoints, such as voice, chat, emails, etc.
Manual and time-consuming methods of CX process transformation, relying on human auditors and manual scoring.
Optimizing CX processes using AI-driven recommendations and personalized training modules for agents and voice-bots.

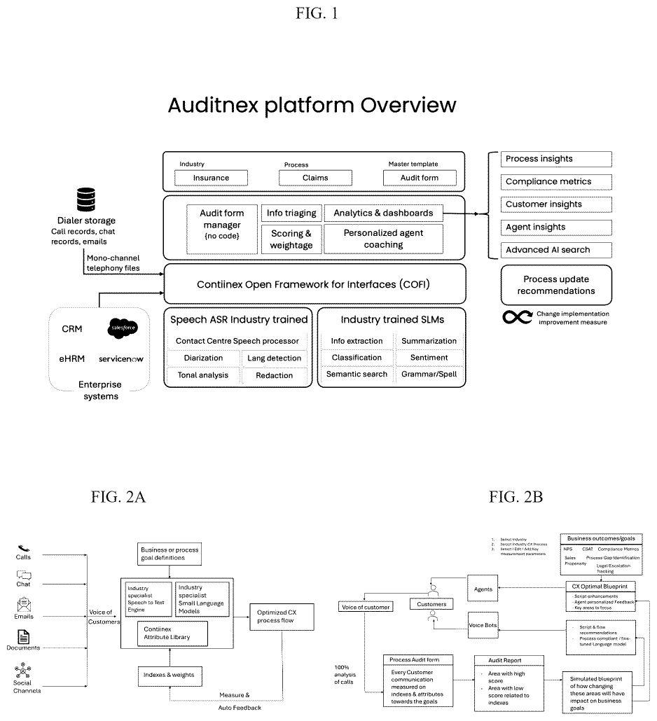

The overall design of the system disclosed in the present invention is shown in FIG. 1.

In the present invention, the business insights include process insights, compliance metrics, customer insights and agent insights. The language model comprises a set of industry-trained small-scale language models optimized for analyzing domain-specific VoC data. The speech-to-text model comprises an industry-specialized speech engine designed to convert voice data into text with high accuracy, tailored for domain-specific terminologies. Further the specifications of the GPU machine used in the present invention is listed in Table 1 and 2 respectively.

| Properties | Training/Fine-Tuning |
|---|---|
| Instance Type | G4ad.xlarge |
| Storage | >=600 GB |
| Memory | >=16 GB |
| Processor | vCPUs -4 |
| | NVIDIA Container Toolkit 1.4/ |
| | NVIDIA Container Runtime 3.4 |
| Graphics | AMD Radeon Pro v520 |
| | (CUDA & NVIDIA Driver) |
| OS | Ubuntu 20.04 |

| Properties | Inference and Other Services | |
|---|---|---|
| Instance Type | g5.4xlarge (1 GPU with | |
| | GPU memory-24 GiB) | |
| Storage | >=600 | GB |
| Memory | >=64 | GiB |

| | |
|---|---|
| Processor | vCPUs-16 |
| | NVIDA Container Toolkit 1.4/ |
| | NVIDIA Container Runtime 3.4 |
| Graphics | AMD Radeon Pro |
| | (CUDA & NVIDIA Driver) |
| OS | Ubuntu 20.04 |

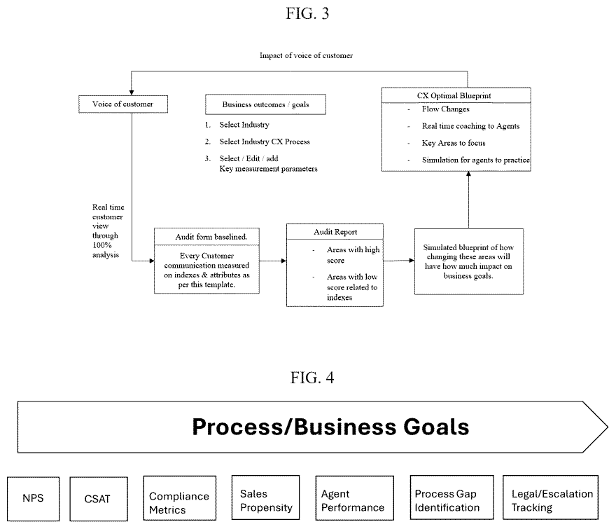

The method disclosed in the present invention is shown in the form of flow diagram in FIGS. 2A and 2B respectively. In the first step, the business objectives/process goals for a business organization are defined. After defining, these objectives are mapped to key performance indices of the business organization. Then, the voice of customer data is collected from various channels like voice calls, recorded call data, live call interactions, chat messages, emails, customer notes, forms, documents, and records through interfaces. The key knowledge management system and CRM map customer information collected from various channels to triage with the collected voice of customer data. Then, each business objective and its related key performance indices are mapped to attributes which are to be identified in the voice of customer data. The voice of customer data is analysed to find results and weightages for each attribute and the key performance indices. After analysing the data, process transformation report is generated to recommend changes for enhancing the key performance indices. After generating report, the key performance indices are continuously measured and monitored till optimal thresholds are reached. The impact of this method is shown in the form of a flow diagram in FIG. 3.

According to the present invention, the process/business goals defined in first step of the method disclosed in the present invention is shown in FIG. 4. The business goals include Net Promoter Score (NPS), Customer Satisfaction Score (CSAT), Compliance metrics, Sales propensity, Agent performance, Process gap identification, Legal escalation tracking. These business objectives are mapped with key performance indices which are a measurement for indicating the performance of an organization. Similarly, knowledge management system is an IT system which stores and provides knowledge for improving the collaboration and process alignment. The method makes use of knowledge management system along with Customer Relationship Management (CRM) for mapping customer information collected from various channels with collected voice of customer data. Generally, CRMs are employed by organizations to manage and analyse customer data and interactions throughout the customer lifecycle.

The process transformation report which includes category, parameter, sub-parameter and weightage are shown in Table 3 given below. In each category, there are various parameters and each parameter has various sub parameter for which weightage scores are given.

| Category | Parameter | Sub Parameter | Weightage |
|---|---|---|---|
| Customer | Proper greeting | Did the agent greet the patient/customer | 1 |
| Engagement | and introduction | appropriately? | |
| | | Did the agent provide a clear introduction of | 1 |
| | | themselves and their company? | |
| | | Was any necessary disclaimer provided clearly and | 1 |
| | | in a timely manner? | |
| | | Was the agent confirming if they are speaking to | 1 |
| | | the right person? | |
| | Empathy & | Did the agent demonstrate empathy? | 1 |
| | apology | Did the agent apologise to the customer's wher | 1 |
| | | necessary? | |
| | Active listening | Did the agent actively listen to the customer's | 2 |
| | | concerns? | |
| | | Did the agent demonstrate confidence throughout | 2 |
| | | the interaction? | |
| | Clarity of | Was the agent's enthusiasm and energy level | 2 |
| | communication | appropriate and engaging? | |
| | | Agent was patient and did not interrupt the | 2 |
| | | customer | |
| | | Were explanations and instructions clear and easily | 2 |
| | | understood? | |
| | Tonality and call | Did the agent maintain a professional and courteous | 2 |
| | etiquette | tone throughout the call? | |
| | | Did the agent match their pace and language to the | 2 |
| | | customer's level of understanding? | |
| | | Did the agent personalize the interaction to make | 2 |
| | | the customer feel valued? | |
| Administrative | Member and Case | Was the member ID captured correctly? | 2 |
| Process | Information | Was the case number captured correctly? | 2 |
| | Contact and | Contact Type | 2 |
| | Representative | | |
| | Details | Healthcare Representative Label | 2 |
| | Case | Case Type | 2 |
| | Classification | | |
| Compliance | HIPAA | HIPAA verified and documented (Member ID, | 2 |
| and Process | Compliance | Member Name, Date of Birth, Provider Tax ID/NPI | |
| Adherence | | Number) | |
| | | HIPAA error drilldown | 2 |
| | | Member Representative Authentication | 2 |
| | Case Management | Was the case tasked appropriately? | 2 |
| | | If the case is expedited, was it triaged and | 2 |
| | | documented as expedited? | |
| | Provider and | Addresses reviewed and updated for all 3 providers - | 2 |
| | Authorization | Requesting, Treating & Facility | 2 |
| | Details | Was the Diagnosis code entered correctly? | 2 |
| | | Were authorization details captured? | 2 |
| | | Was Notification Date entered correctly? | 2 |
| | | Notification reason inserted correctly | 2 |
| | | Auth type inserted correctly | 2 |
| | | Date of Service verified/inserted correctly | 2 |
| | Notification and | Was the case processed within time frame required? | 2 |
| | Processing | Did the Agent display positive scripting and made | 1 |
| | | use of power words through out the call? | |
| | Script Adherence | Did the Agent provide a summary of what has | 1 |
| | and | transpired? | |
| | Summarization | | |
| | Issue Resolution | Was the issue resolved? | 2 |
| | and Accuracy | Accurate Information gathered? | 2 |
| | | Did the agent maintain a professional demeanor | 2 |
| | | without being rude or overty casual? | |
| | | No profanities used | 1 |
| | | Agent did not avoid the call or deliberately | 1 |
| | | disconnect the call? | |
| Health | Health Outcome | Was a notification sent when necessary? (outreach | 1 |
| Outcome | | to member or provider on any missing or pending | |
| Process | | information required to complete case) | |
| | Clinical | Clinical information was requested? (if necessary) | 1 |
| | Information | | |
| Call Closure | Call Disposition | Did the agent ask the patient or the customer if | 2 |
| | | there is anything else they them assist the patient | |
| | | with? | |
| | | Did the agent close the call by thanking the | 2 |
| | | customer/patient? | |
| Business | Capturing voice | Customer Feedback on agent conversation | 2 |
| Insights | of the customer | Customer concerns or escalation | 2 |
| | | Customer Legal actions | 2 |
| | Competitor | Competitor comaprison on service | 1 |
| | Analysis | Competitor comaprison on offerings | 1 |
| | NPS on survey | Promoter | 1 |
| | | Neutral | 1 |
| | | Detractor | 1 |
| | | Did the agent ensure the customer's satisfaction | 2 |
| | | with the resolution or outcome? | |
| | Customer | Based on the customer's feedback, how likely are | 2 |
| | satisfaction | they to recommend the service to others? | |
| | Sentiment | Based on the customer's tone and language, how | 2 |
| | analysis | would you rate the overall sentiment (positive, | |
| | | negative, or neutral)? | |
| | Customer Profile | Not interested | 1 |
| | | Warm lead to follow up | 1 |
| | | Interested | 1 |
| | Inbound Channel | Website | 1 |
| | | App service | 1 |
| | | Call | 1 |
| | | WhatsApp | 1 |
| | | | 100 |

The optimal threshold upto which the key performance indices are continuously measured and monitored in the method disclosed in the present invention is shown in Table 4 which is given below:

| | Optimal | Current | |
|---|---|---|---|
| Business Goals | Threshold | Level | Status |
| NPS | >96% | 92% | In Progress |
| CSAT | >97% | 85% | Process changed |
| Compliance Metrics | >95% | 92% | In Progress |
| Sales Propensity | >35% | 42% | Achieved |
| Agent Performance | >95% | 85% | In Progress |
| Process Gap Identification | >75% | 35% | Process changed |
| Legal/Escalation Tracking | >97% | 92% | In Progress |

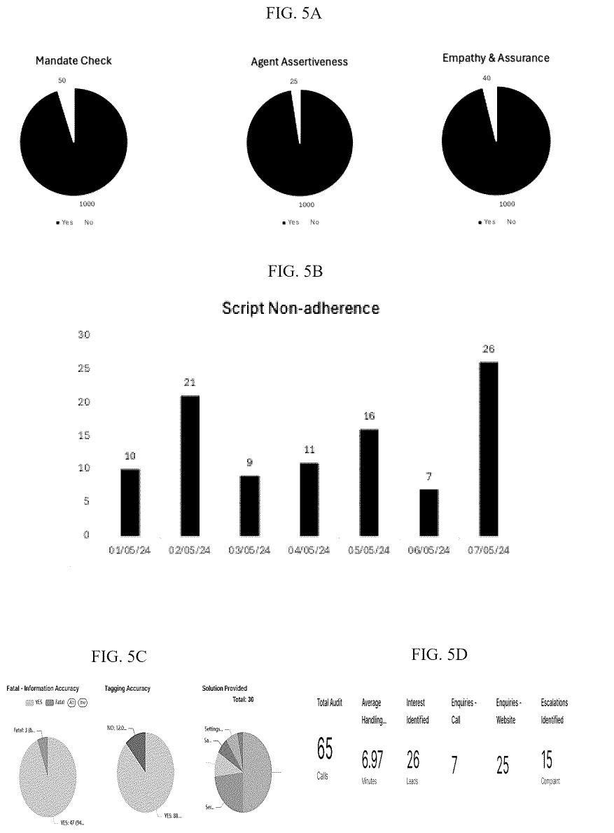

A sample analysis of the various parameters considered in the method disclosed is shown in FIGS. 5A. 5B, 5C and 5D.

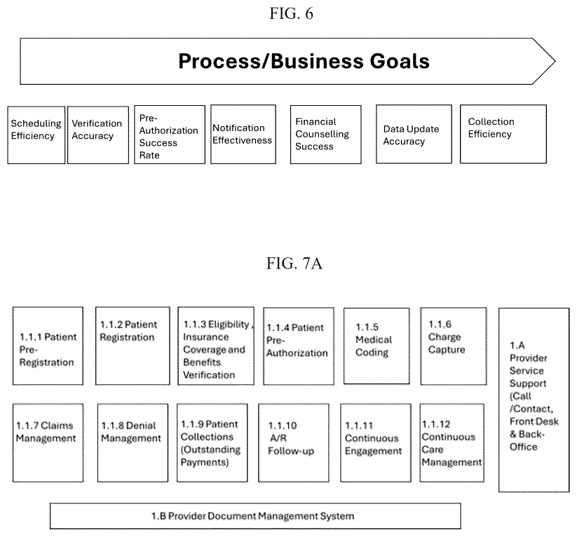

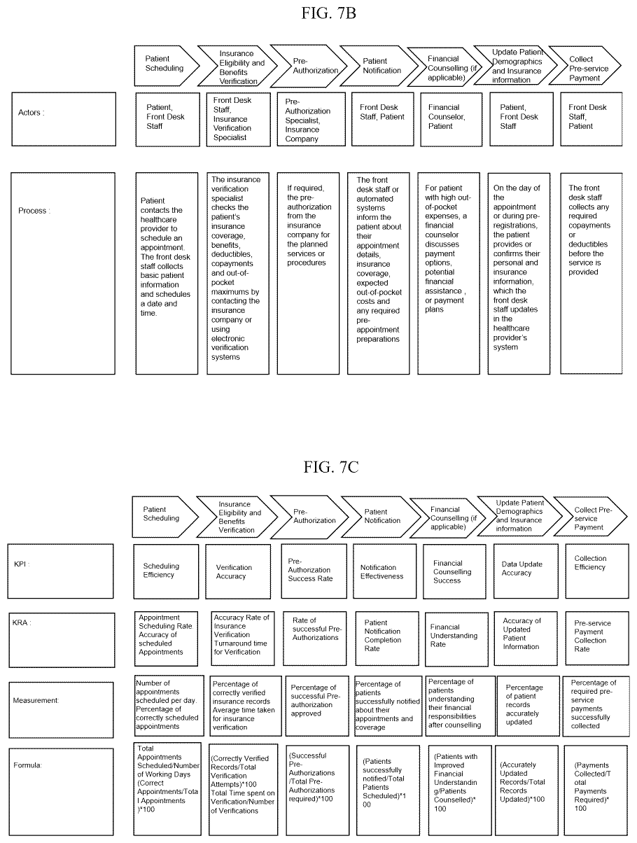

An example application of the present invention is in healthcare industry and its process/business goals is shown in FIG. 6. This includes scheduling efficiency, verification accuracy, pre-authorization success, notification effectiveness, financial counselling success, data update accuracy and collection efficiency. The working of the example application is shown in the FIGS. 7A, 7B and 7C respectively. The optimal threshold upto which the key performance indices are continuously measured and monitored in the example application of the present invention is shown in Table 5 which is given below:

| | Optimal | Current | |
|---|---|---|---|
| Business Goals | Threshold | Level | Status |
| Scheduling Efficiency | >96% | 92% | In Progress |
| Verification Accuracy | >97% | 92% | In Progress |
| Pre-Authorization Success Rate | >95% | 92% | In Progress |
| Notification Effectiveness | >95% | 85% | In Progress |
| Voice Bot Performance | >95% | 85% | Process Changed |
| Data Update Accuracy | >75% | 35% | Process changed |
| Collection Efficiency | >97% | 92% | In Progress |

To summarize, the method disclosed in the present invention automatically identifies the key performance factors which are essential to meet the process objectives, align an audit form and parameters with these key performance factors and analyse 100% of voice of customers across channels to measure the status of each of these attributes, adjust weightages of these attributes based on the process for it to reach optimal outcome and recommend process changes. The method also generates process recommendation changes based-agent training capsules and agent simulated practice sessions. The method prompt agents as per the refined process in real-time and consolidating data from the interface systems, reward higher audit scores for adherence to refined process, driving higher process objectives and automatic information update-based analysis of refined process and aligns with set process goals. Further, voice bots are deployed in the present invention that function to these optimal CX framework, measure the on-going changes and continue fine-tuning of the process till the process objectives meet the optimal values for the enterprise.

The method disclosed in the present invention ensures high accuracy of input data and a closed-loop feedback approach by automation of information update into enterprise system by extracting data from customer conversation. This method reduces human biases in CRM disposition and updates and subjectivity and errors caused by human updates. The automatic updates become the source of CX process audit to recommend optimization. Thus, this closed-loop ensures automatic process refinement with accurate data input.

These steps continue till the set process goal metrics are met and continued to improve to surpass the set goals. The data resides on the private cloud (behind the firewall) ensuring complete data security & privacy.

The method disclosed in the present invention has the following advantages but not limited to:
Delight customers with personalized experiences
Increase retention and loyalty through improved CX
Upsell and cross-sell with targeted recommendations
Achieve higher NPS through continuous process optimization
Automation of voice of customer to business transformation actions
Key insights in the voice of customer extracted and mapped to desired business outcomes
Key recommendations suggested through insights extracted from voice data
End to end digitization of the process making it fast, accurate, holistic, cost effective and applicable across any CX process
Ensure data privacy and security for the analysis and reports

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope of the invention as claimed.

What is claimed is:

1. A system for optimizing customer experience transformation by analysing voice-of-customer (VoC) data using artificial intelligence (AI) and machine learning (ML) techniques, wherein the system comprises of:
a. a distributed storage architecture for storing structured and unstructured VoC data in a scalable data lake for real-time data retrieval and analysis from various customer feedback channels and business insights;
b. a multi-channel ingestion framework utilizing APIs, edge computing, and secure data protocols for collecting and pre-processing voice-of-customer data from social media, call centers, emails, and enterprise systems, for seamless integration of data from diverse sources;
c. a language model and an end-to-end speech-trained model employing advanced techniques such as transformers and convolutional neural networks to process, analyze, and interpret VoC data, offering high accuracy in sentiment detection, intent recognition, and predictive analytics across multiple languages and accents;
d. a real-time anomaly detection and predictive analytics engine leveraging ensemble learning and unsupervised ML techniques to identify outliers, detect emerging trends, and predict future customer behaviors, ensuring continuous improvement in customer experience strategies; and
e. a secure and compliant data privacy mechanism, incorporating encryption standards and differential privacy algorithms to protect customer data ensuring compliance with global data protection regulations during AI/ML model training and operation.

2. The system as claimed in claim 1, wherein the business insights include process insights, compliance metrics, customer insights and agent insights.

3. The system as claimed in claim 1, wherein the language model comprises a set of industry-trained small-scale language models optimized for analyzing domain-specific VoC data.

4. The system as claimed in claim 1, wherein the speech-to-text model comprises an industry-specialized speech engine designed to convert voice data into text with high accuracy, tailored for domain-specific terminologies.

5. A method for optimizing customer experience transformation by analysing voice-of-customer using artificial intelligence (AI) and machine learning (ML) techniques, wherein the method comprises the steps of:
a. defining business objectives for a business organization;
b. mapping the defined business objectives to key performance indices (KPIs) relevant to the organization;
c. providing interfaces for collecting voice of customer data from various communication channels including social media, emails, call centers, and web forms;
d. integrating knowledge management systems and customer relationship platform (CRM) platforms to associate customer data with the collected VoC data for further analysis;
e. mapping each business objective and corresponding KPIs to relevant attributes to be identified within the VoC data;
f. analysing the VoC data using an NLP-based language model and speech-trained model to determine attribute values and weighted contributions to each KPI, with high accuracy in sentiment detection and intent recognition across multiple languages and dialects;
g. utilizing a real-time anomaly detection and predictive analytics engine to identify outliers, detect emerging trends, and predict customer behaviors, and generating a process transformation report with recommendations for optimizing business processes and enhancing the KPIs; and
h. continuously monitoring and measuring the KPIs to ensure performance targets and optimal thresholds are achieved, utilizing predictive analytics for proactive customer experience improvements.

6. The method as claimed in claim 5, wherein the various channels comprise voice calls, recorded call data, live call interactions, chat messages, emails, customer notes and business documents.
